(19) United States
(12) Patent Application Publication
(10) Pub. No.: US 2024/0052989 A1
(43) Pub. Date: Feb. 15, 2024

(54) ILLUMINATION MODULE WITH MULTI LIGHT SOURCES AND HEADLIGHT HAVING THE SAME

(71) Applicant: COPLUS INC., Tainan City (TW)

(72) Inventor: Jacob Wu, Tainan City (TW)

(21) Appl. No.: 17/945,774

(22) Filed: Sep. 15, 2022

Related U.S. Application Data
(60) Provisional application No. 63/397,711, filed on Aug. 12, 2022.

(51) Int. Cl. F21S 41/33; F21S 41/27; F21S 41/143

(52) U.S. Cl. CPC F21S 41/334; F21S 41/27; F21S 41/143

(57) ABSTRACT

The present invention is an illumination module with multi light sources incudes at least one first optical adjustment unit, at least one first light source, at least one second optical adjustment unit and at least one second light source. The first light source is configured to generate a first color light, and projects the first color light to the first optical adjustment unit, such that the first optical adjustment unit projects the first color light to a front of the illumination module with multi light sources. The second light source is configured to generate a second color light, and projects the second color light to the second optical adjustment unit, such the second optical adjustment unit projects the second color light to the front of the illumination module with multi light sources, wherein the first color light and the second color light partially or fully overlap.

### REFERENCE TO RELATED APPLICATIONS

This non-provisional application claims priority under 35 U.S.C. § 119(a) on U.S. Provisional Application No. 63/397,711 filed Aug. 12, 2022, the entire contents of which are incorporated herein by reference.

### BACKGROUND

### Technical Field

This disclosure is related to vehicle parts, in particular to an illumination module with multi light sources and vehicle lamp having the illumination module.

### Related Art

Compared with incandescent lamps, LEDs have the advantages of small size, high brightness, long service life and power saving. LEDs have been used in automotive headlamps to produce high brightness white light, which can achieve good lighting effects under normal conditions. However, the color temperature of the white light generated by LED automotive headlamps is relatively high and often does not achieve the desired lighting effect in bad weather conditions, such as rainy weather, snowy weather or foggy weather. The white light may also affect the driver's vision, which in turn affects the safety of driving.

Therefore, in bad weather, drivers often need to turn on the fog lights and illuminate with the white light from the LED vehicle lamp set to increase the safety of driving. However, the fog lights are installed in a low position and irradiated at a close distance, which usually only have the effect of warning and do not provide good lighting effect. In addition, fog lights are mostly stand-alone, not even standard equipment when the car is sold. Additional retrofitting also increases installation costs.

### SUMMARY

In order to improve the shortcomings of the traditional LED headlamp in the art, this disclosure further proposes to set up a multiple color light sources in the vehicle lamp, which can generate different color lights at the same time and can significantly improve the problem of poor lighting effect of the LED headlamp in bad weather.

To achieve the object, this disclosure provides an illumination module with multi light sources, which comprises at least one first optical adjustment unit; at least one first light source configured to generate a first color light, and projects the first color light to the first optical adjustment unit, wherein the first optical adjustment unit is configured to project the first color light to a front of the illumination module with multi light sources; at least one second optical adjustment unit; at least one second light source configured to generate a second color light, and projects the second color light to the second optical adjustment unit, wherein the second optical adjustment unit is configured to project the second color light to the front of the illumination module with multi light sources, and the first color light and the second color light partially or fully overlap.

This disclosure further provides a vehicle lamp, which comprises the above-mentioned plurality of illumination modules integrated into a lamp housing.

In practical application, an ordinary headlamp can be directly replaced by the illumination module with multi light sources described in this disclosure, and the light control lever in the vehicle can be adjusted to enable the vehicle to emit a bad weather light source. In other words, the headlamp described in the present disclosure can be quickly and conveniently installed on an ordinary vehicle and improve the safety of the vehicle.

### BRIEF DESCRIPTION OF THE DRAWINGS

This disclosure will become more fully understood from the detailed description given herein below for illustration only, and thus not limitative of this disclosure, wherein:

FIG. 1 is a schematic structural diagram of a vehicle lamp having an illumination module with multi light sources according to an embodiment of this disclosure.

FIG. 2 is a cross-sectional view of the illumination module with multi light sources according to an embodiment of this disclosure.

FIG. 3 is a cross-sectional view of the illumination module with multi light sources according to another embodiment of this disclosure.

FIG. 4 is a cross-sectional view of the illumination module with multi light sources according to another embodiment of this disclosure.

FIG. 5 is a top cross-sectional view of the illumination module with multi light sources according to an embodiment of this disclosure.

FIG. 6 is a side cross-sectional view of the illumination module with multi light sources according to an embodiment of this disclosure.

FIG. 7 is a schematic three-dimensional diagram of the illumination module with multi light sources according to an embodiment of this disclosure.

FIG. 8 is a schematic three-dimensional diagram of the illumination module with multi light sources according to another embodiment of this disclosure.

FIG. 9 is a schematic structural diagram of a vehicle lamp having an illumination module with multi light sources according to another embodiment of this disclosure.

FIG. 10 is a schematic structural diagram of a vehicle lamp having an illumination module with multi light sources according to another embodiment of this disclosure.

FIG. 11 is a schematic structural diagram of a vehicle lamp having an illumination module with multi light sources according to another embodiment of this disclosure.

FIG. 12 is a schematic three-dimensional exploded diagram of the illumination module with multi light sources according to another embodiment of this disclosure.

FIG. 13 is a connection diagram of light sources, a control circuit and a switch of the illumination module with multi light sources according to an embodiment of this disclosure.

FIG. 14 is a connection diagram of light sources and the control circuit of the illumination module with multi light sources according to another embodiment of this disclosure.

FIG. 15 is a connection diagram of light sources and the control circuit of the illumination module with multi light sources according to another embodiment of this disclosure.

### DETAILED DESCRIPTION

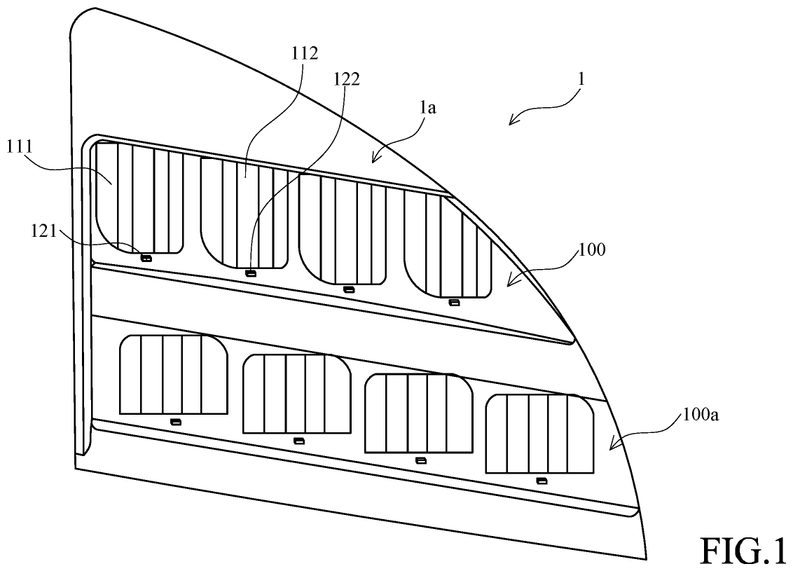

FIG. 1 is a schematic structural diagram of a vehicle lamp with an illumination module according to an embodiment of this disclosure. The vehicle lamp 1 comprises a plurality of illumination modules 100 with multi light sources, wherein illumination modules 100 are integrated into a lamp housing 1a. In one specific embodiment, the vehicle lamp 1 may be a headlight for vehicle. In practical application, an ordinary headlamp can be directly replaced by the vehicle lamp 1 described in this disclosure, so as to improve the lighting effect and safety of the vehicle.

In one specific embodiment, the vehicle lamp 1 may further includes an auxiliary illumination module 100a integrated in the lamp housing 1a. In one embodiment of this disclosure, the illumination module 100 may be a low beam module, and the auxiliary illumination module 100a may be a high beam module. In another embodiment of this disclosure, the illumination module 100 may be the high beam module, and the auxiliary illumination module 100a may be the low beam module.

As shown in FIG. 1, the illumination module 100 with multi light sources includes at least one first optical adjustment unit 111, at least one first light source 121, at least one second optical adjustment unit 112 and at least one second light source 122.

As shown in FIG. 1, the first light source 121 is configured to generate a first color light L1, and projects the first color light L1 to the first optical adjustment unit 111, such that the first optical adjustment unit 111 projects the first color light L1 to the front of the illumination module 100 with multi light sources. The second light source 122 is configured to generate a second color light L2, and projects the second color light L2 to the second optical adjustment unit 112, such that the second optical adjustment unit 112 projects the second color light L2 to the front of the illumination module 100 with multi light sources, wherein the first color light L1 and the second color light L2 partially or fully overlap.

The first light source 121 and the second light source 122 are respectively configured to generate the first color light L1 and the second color light L2. The first color light L1 and the second color light L2 are light with different wavelengths, colors or color temperature. For example, the first color light L1 is white light, and the second color light L2 is yellow light. In one specific embodiment, the first light source 121 and the second light source 122 are LEDs, but other type of light sources is not excluded in this disclosure.

The first optical adjustment unit 111 and the second optical adjustment unit 112 may be a reflecting cup or a lens.

As shown in FIG. 1, the first optical adjustment unit 111 and the second optical adjustment unit 112 are reflecting cups. The first optical adjustment unit 111 and the second optical adjustment unit 112 are disposed on the lamp housing 1a and spaced from each other. The first light source 121 and the second light source 122 are also disposed on the lamp housing 1a. The first light source 121 and the second light source 122 respectively project the first color light L1 and the second color light L2 to the first optical adjustment unit 111 and the second optical adjustment unit 112. The first optical adjustment unit 111 and the second optical adjustment unit 112 respectively reflect the first color light L1 and the second color light L2, and the first color light L1 and the second color light L2 are projected to the front of the illumination module 100 with multi light sources, wherein the reflected first color light L1 and reflected the second color light L2 project to approximately overlapping angular ranges. The first optical adjustment unit 111 and the second optical adjustment unit 112 shown in FIG. 1 may be two independent elements, which are respectively assembled to the lamp housing 1a.

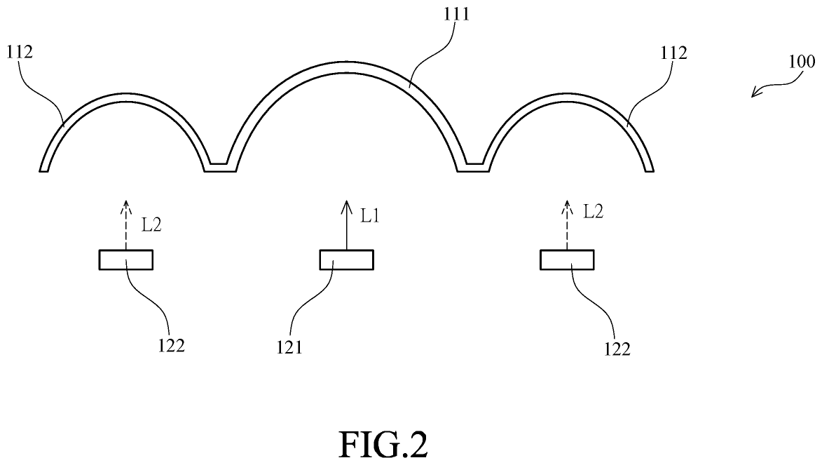

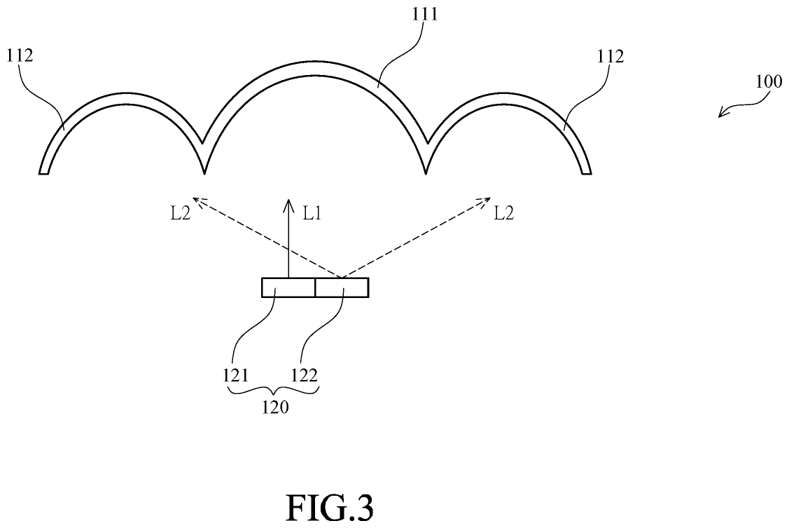

As shown in FIG. 2 and FIG. 3, the first optical adjustment unit 111 and the second optical adjustment unit 112 are reflecting cups, and the edges of them are fitted together to form a single component. Further, the single component is disposed in the lamp housing 1a, which is convenient for production assembly. The difference between FIG. 2 and FIG. 3 is that, in the embodiment of FIG. 2, there is a distance between two adjacent reflecting cups, so two adjacent reflecting cups are connected to each other through a horizontal extension. In the embodiment of FIG. 3, the edges of two reflecting cups are connected to each other.

In addition, as shown in FIG. 3, the first light source 121 and the second light source 122 are adjacent to each other. Plural first light sources 121 and plural second light sources 122 are closely arranged into a light source array 120. Each of the first light sources 121 and each of the second light sources 122 may face or correspond to the first optical adjustment unit 111 and the second optical adjustment unit 112 to reflect the first color light L1 and the second color light L2 toward different angle range.

As shown in FIG. 3, the first light source 121 and the second light source 122 may be fitted together as the light source array 120, and the first light source 121 and the second light source 122 face or correspond to the first optical adjustment unit 111 and the second optical adjustment unit 112. The first optical adjustment unit 111 is configured to reflect the first color light L1 generated by the first light source 121, and the second optical adjustment unit 112 is configured to reflect the second color light L2 generate by the second light source 122. In practical application, the first optical adjustment unit 111 may reflect part of the second color light L2, and the second optical adjustment unit 112 may reflect part of the first color light L1. The reflected first color light L1 and the reflected second color light L2 are projected in the front of the illumination module 100 with multi light sources, wherein the first color light L1 and the second color light L2 partially or completely overlap.

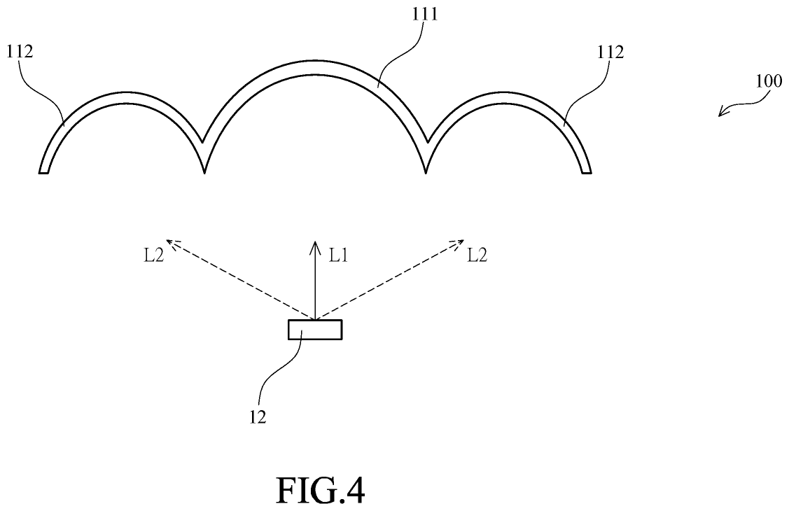

As shown in FIG. 4, the first light source 121 and the second light source 122 may be combined into a single variable color light module 12. For example, the variable color light module 12 may include two LED dies, and the two LED dies are packaged to form a LED device and can be used to generate color light of diverse colors. The variable color light module 12 is configured to generate the first color light L1 and the second color light L2. For example, the first color light L1 and the second color light L2 project to the first optical adjustment unit 111 and the second optical adjustment unit 112, and then are projected to the front of the illumination module 100 with multi light sources through a similar optical path, such that the reflected first color light L1 and the reflected second color light L2 project to approximately overlapping angular ranges.

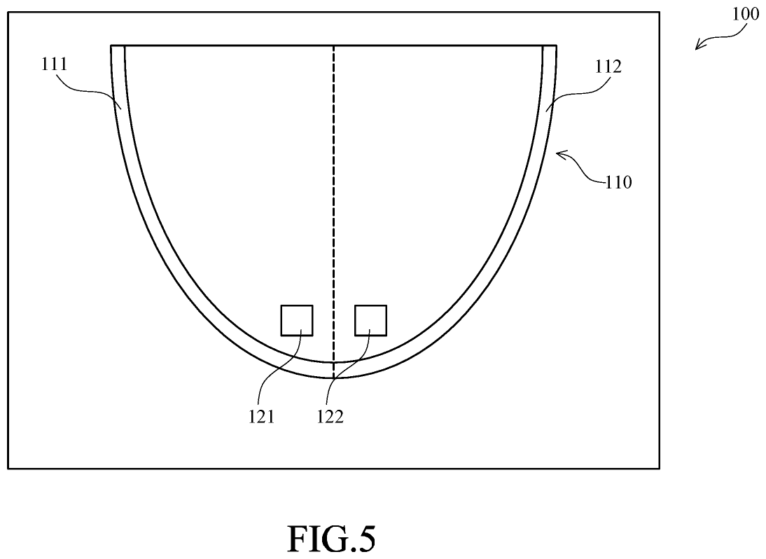

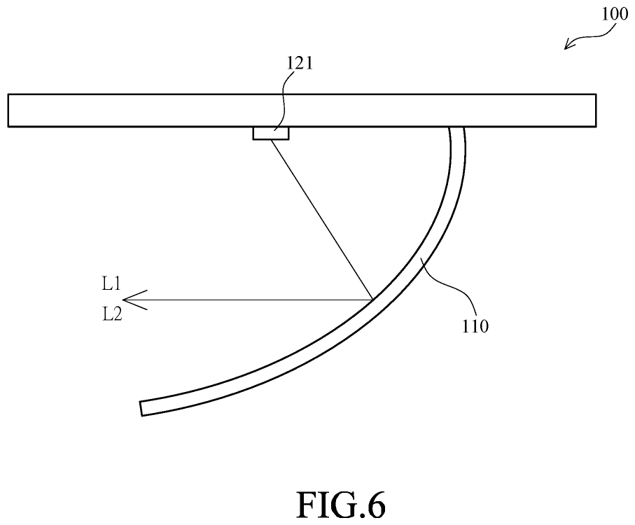

As shown in FIG. 5 and FIG. 6, FIG. 5 is a top cross-sectional view of the illumination module 100 with multi light sources, and FIG. 6 is a side cross-sectional view of the illumination module 100 with multi light sources. The first optical adjustment unit 111 and the second optical adjustment unit 112 may be combined into a single reflecting cup 110 with a continuous surface, and the first light source 121 and the second light source 122 are located in the reflecting cup 110. Specifically, the first optical adjustment unit 111 and the second optical adjustment unit 112 may be obtained by cutting a single reflecting cup into two parts. Further, the second light source 122 is blocked by the first light source 121, so only the first light source 121 is shown in FIG. 6.

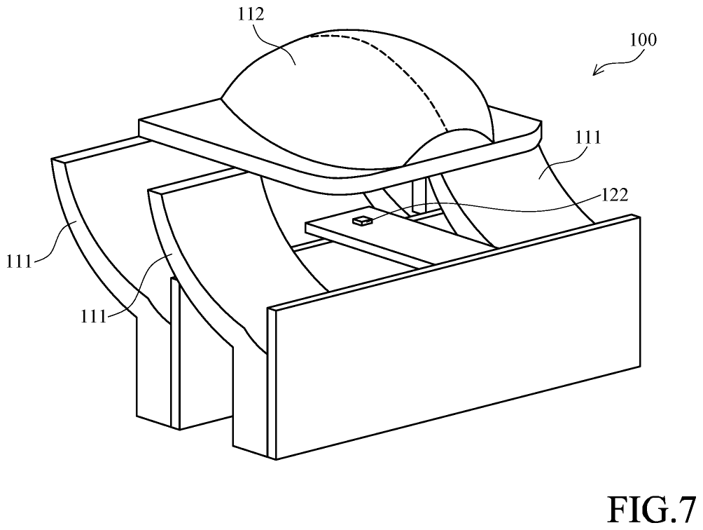

As shown in FIG. 7, in another example, the first optical adjustment unit 111 is a reflecting cup, and the second optical adjustment unit 112 is a lens. The first light source 121 faces the first adjustment unit 111, and the first adjustment unit 111 is configured to reflect the first color light L1 generated by the first light source 121. The second adjustment unit 112 is configured to refract the second color light L2 generated by the second light source 122, and the reflected first color light L1 and the refracted second color light L2 partially or fully overlap.

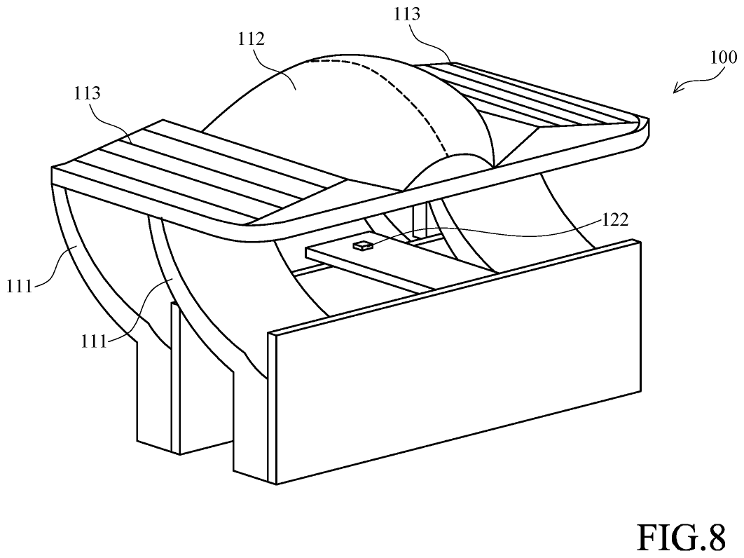

As shown in FIG. 8, a third optical adjustment unit 113 may be arranged on the optical path of the first color light L1. The first color light L1 reflected by the first optical adjustment unit 111 is projected to the third optical adjustment unit 113, and then the first color light L1 is projected to the front of the illumination module 100 with multi light sources through the third optical adjustment unit 113. For example, the third optical adjustment unit 113 may be a projection lens.

In addition, the third optical adjustment unit 113 may be connected to the second optical adjustment unit 112, and is the extension member of the second optical adjustment unit 112. For example, the first light source 121 may be located on both sides of the second light source 122, and the third optical adjustment units 113 may be located on both sides of the second optical adjustment unit 112.

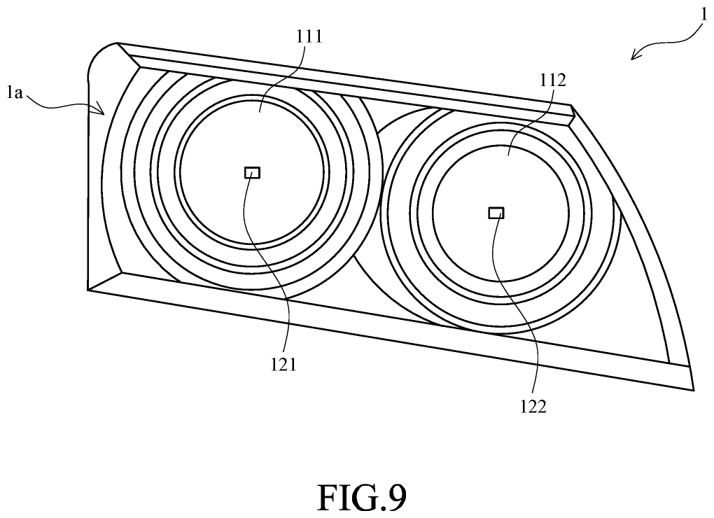

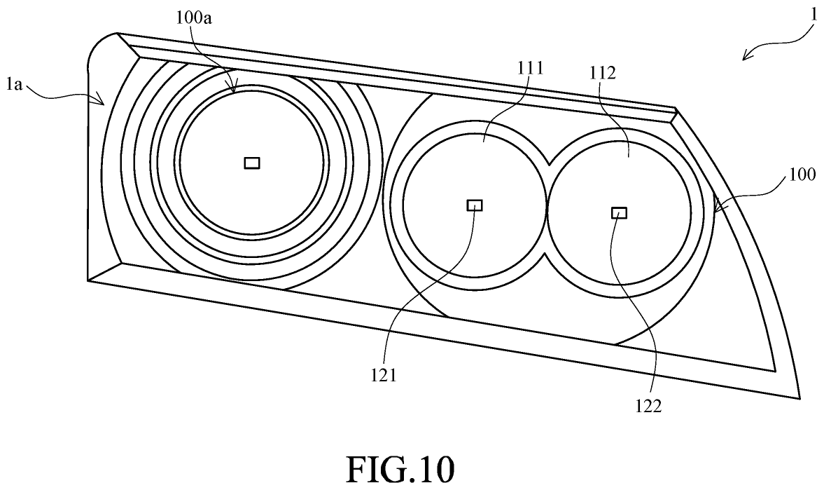

As shown in FIG. 9 and FIG. 10, in another example, the first optical adjustment unit 111 and the second optical adjustment unit 112 are lens spaced from each other.

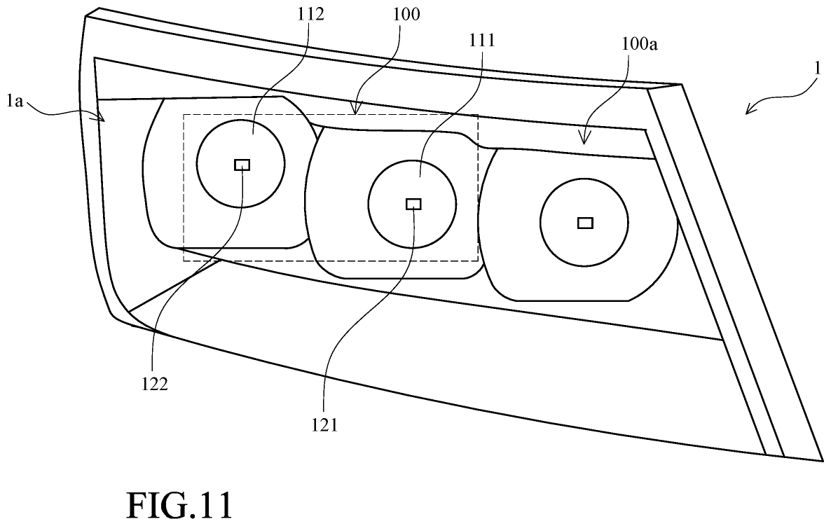

As shown in FIG. 11, the vehicle lamp 1 may include the illumination module 100 with multi light sources and an auxiliary illumination module 100a, and both are integrated in the lamp housing 1a, wherein the illumination module 100 with multi light sources includes a first optical adjustment unit 111, a first light source 121, a second optical adjustment unit 112 and a second light source 122. For example, the illumination module 100 may be a low beam module, and the auxiliary illumination module 100a may be a high beam module.

In one embodiment of this disclosure, the first optical adjustment unit 111 and the first light source 121 may be combined into a lighting unit, while the second optical adjustment unit 112 and the second light source 122 may be combined into another light unit. In another embodiment of this disclosure, the second optical adjustment unit 112 and the second light source 122 may be integrated into the auxiliary illumination module 100a.

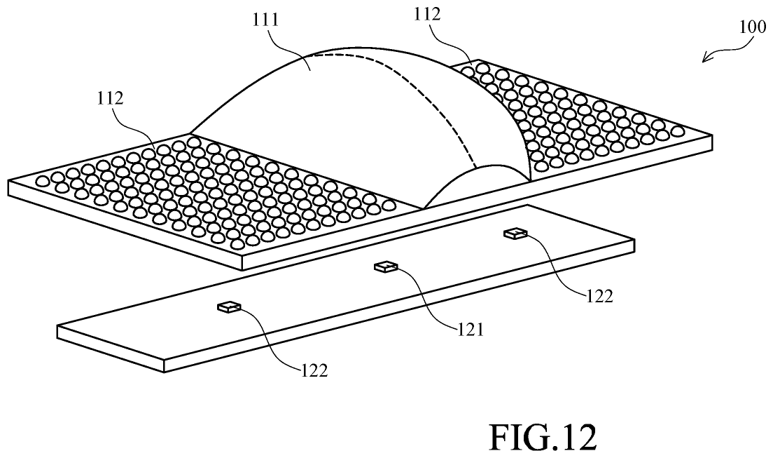

As shown in FIG. 12, the illumination module 100 with multi light sources includes a first optical adjustment unit 111, a first light source 121, two second optical adjustment units 112 and two second light sources 122. The first optical adjustment unit 111 and the second optical adjustment unit 112 are not limited to lenses with a single optical axis. The first optical adjustment unit 111 may be a lens with a single optical axis, and is disposed on the optical path of the first color light L1 generated by the first light source 121. The second optical adjustment unit 112 may be an optical diffusion element with a diffusing function, such as a diffuser plate, and the surface of the second optical adjustment unit 112 may have concave or convex pattern, wherein the second optical adjustment unit 112 is disposed on the optical path of the second color light L2 generated by the second light source 122. In other embodiment, the second optical adjustment unit 112 may be a reflective diffusion element, which is configured to reflect the second color light L2 generated by the second light source 122 to a predetermined direction or area.

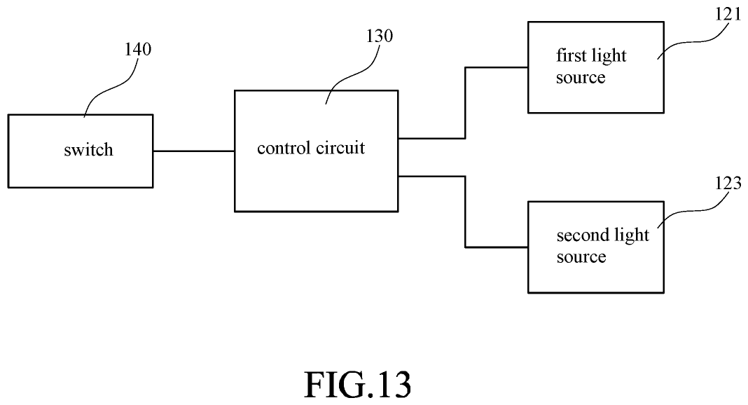

As shown in FIG. 13, the illumination module 100 with multi light sources further includes a control circuit 130 and a switch 140. The control circuit 130 is configured to control turn-on/turn-off of the first light source 121 and the second light source 122. For example, the control circuit 130 may be a multistage toggle switch. The switch 140 may be a high beam switch or an overtaking light switch of the vehicle. The switch 140 is configured to transmit a trigger signal to the control circuit 130, and the control circuit 130 turns on or turns off the first light source 121 and the second light source 122 according to the trigger signal.

When the first light source 121 is turned on, the control circuit 130 turns on or off the second light source 122 by accepting the trigger signal for a specific number of times as a cycle of triggering. For example, the switch 140 turns on the second light source 122 every three times it is triggered, and then turns off the second light source 122 when it is triggered again, until switch 140 is triggered another three times and turns on the second light source 122 again.

Specifically, the illumination module 100 with multi light sources of this disclosure may have three operation modes. The first operation mode is the first light source 121 and the second light source 122 are not emitting light, which is usually applied in the daytime or a well-lit driving environment.

The second operation mode is that the first light source 121 and the second light source 122 of the illumination module 100 emit light simultaneously. The first light source 121 is turned on at first to emit the first color light L1, while the second light source 122 is turned off and emits no light. The control circuit 130 receives the trigger signal for the specific number of times when the first light source 121 is turned on, and turns on the second light source 122 to emit the second color light L2 according to the cycle of triggering, and the first light source 121 remains to emit the first color light L1, so that the illumination module 100 with light sources emits the first color light L1 and the second color light L2 simultaneously. The second operation mode is usually used in the night or under-illuminated vehicle environment.

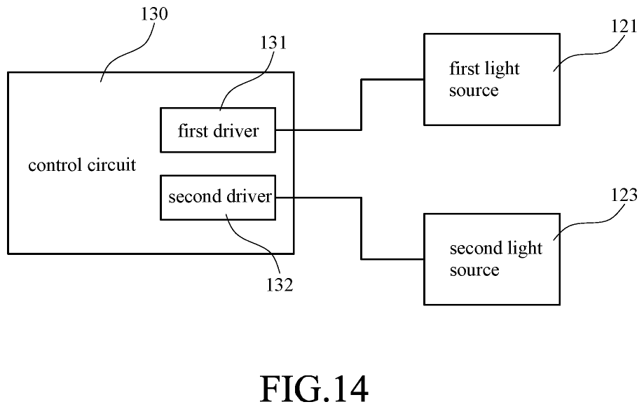

As shown in FIG. 14, in this case, the first light source 121 and the second light source 122 may need be turned on simultaneously, such as in the second operation mode. Therefore, the control circuit 130 may further include a first driver 131 and a second driver 132. The first driver 131 is configured to provide power to the first light source 121, and the second driver 132 is configured to provide power to the second light source 122. The two drivers provide sufficient total electrical power to the first light source 121 and the second light source 122, so as to avoid insufficient luminosity of the first color.

The first driver 131 and the second driver 132 integrated into the control circuit 130 shown in FIG. 14 is only one embodiment of this disclosure, and is not intended to limit the scope of the patent application of the present invention. In other embodiments, the first driver 131 and the second driver 132 may be located outside the control circuit 130 and be connected to the control circuit 130. For example, the first driver 131 is located between the control circuit 130 and the first light source 121, and the second driver 132 is located between the control circuit 130 and the second light source 122.

The third operation mode is that only one of the first light source 121 and the second light source 122 of the illumination module 100 with multiple light sources is turned on. In this case, if the first light source 121 is turned off, the control circuit 130 receives the trigger signal for the specific number of times, and turns on the second light source 122 to emit the second color light L2 according to the cycle of triggering and turns off the first light source 122. If the first light source 121 is turned on and the low beam group is turned on, the control circuit 130 receives the trigger signal for the specific number of times, turns on the second light source 122 according to the cycle of triggering, and turns off the first light source 121.

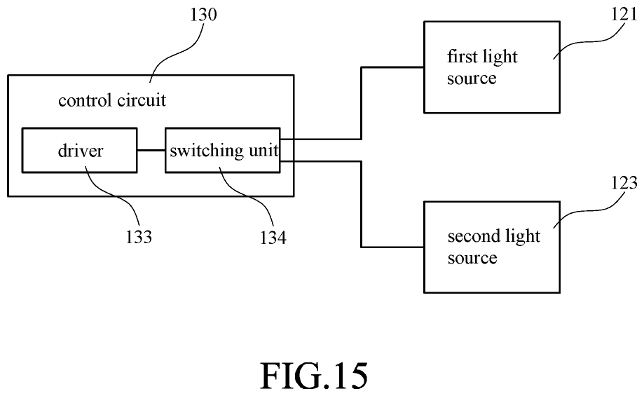

As shown in FIG. 15, in this case, the first light source 121 and the second light source 122 will not be turned on at the same time. Thus, the control circuit 130 only includes a driver 133 and a switching unit 134, wherein the driver 133 is configured to provide power to the switching unit 134, and then the switching unit 134 provides power to the first light source 121 or the second light source 122 depending on demand.

The driver 133 integrated into the control circuit 130 shown in FIG. 15 is only one embodiment of this disclosure, and is not intended to limit the scope of the patent application of the present invention. In other embodiments, the driver 133 may be located outside the control circuit, and be connected to the control circuit 130.

In practical application, the ordinary headlamp can be directly replaced by the illumination module 100 described in this disclosure, and the light control lever in the vehicle can be adjusted, so that the vehicle is able to emit a lighting for bad weather. In other words, the vehicle lamp described in thus disclosure can be quickly and conveniently installed on the general vehicle, so as to improve the safety of the vehicle.

The above description is only a preferred embodiment of this disclosure, and is not intended to limit the scope of this disclosure. Modifications should be included within the scope of the patent application of this disclosure.

1. An illumination module with multi light sources, comprising:
at least one first optical adjustment unit;
at least one first light source configured to generate a first color light, and projects the first color light to the first optical adjustment unit, wherein the first optical adjustment unit is configured to project the first color light to a front of the illumination module with multi light sources;
at least one second optical adjustment unit;
at least one second light source configured to generate a second color light, and projects the second color light to the second optical adjustment unit, wherein the second optical adjustment unit is configured to project the second color light to the front of the illumination module with multi light sources, and the first color light and the second color light partially or fully overlap; and
a control circuit being configured to turn-on or turn-off the first light source and the second light source, and a switch being configured to transmit a trigger signal to the control circuit, wherein the switch is a vehicle light switch of a vehicle;
wherein when the first light source is turned on, the control circuit turns on or off the second light source by accepting the trigger signal for a specific number of times as a cycle of triggering, and the specific number is two or more than two.

2. The illumination module with multi light sources as claimed in claim 1, wherein the first optical adjustment unit and the second optical adjustment unit are a reflecting cup or a lens.

3-5. (canceled)

6. The illumination module with multi light sources as claimed in claim 1, wherein the first optical adjustment unit is a reflecting cup, and the second optical adjustment unit is a lens.

7. The illumination module with multi light sources as claimed in claim 6, further comprising a third optical adjustment unit connected to the second optical adjustment unit, wherein the third optical adjustment unit is located on an optical path of the first color light, the first color light reflected by the first optical adjustment unit projects to the third optical adjustment unit, and project to the front of the illumination module with multi light sources via the third optical adjustment unit.

8. (canceled)

9. The illumination module with multi light sources as claimed in claim 1, wherein the first color light is a white light, while the second color light is a yellow light.

10-12. (canceled)

13. The illumination module with multi light sources as claimed in claim 1, wherein the control circuit further includes a first driver and a second driver, the first driver is configured to provide power to the first light source, and the second driver is configured to provide power to the second light source.

14-15. (canceled)

16. The illumination module with multi light sources as claimed in claim 1, wherein the first light source and the second light source are LEDs.

17. A vehicle lamp, comprising:
a plurality of illumination modules as claimed in claim 1, integrated into a lamp housing.

18. The vehicle lamp as claimed in claim 17, further including at least one auxiliary illumination module integrated into the lamp housing.
